(19) United States
(12) Patent Application Publication
(10) Pub. No.: US 2020/0089151 A1
(43) Pub. Date: Mar. 19, 2020

(54) Image Forming Apparatus

(71) Applicant: Konica Minolta, Inc., Tokyo (JP)

(72) Inventor: Takeshi YOSHINO, Tokyo (JP)

(73) Assignee: Konica Minolta, Inc., Tokyo (JP)

(21) Appl. No.: 16/550,468

(22) Filed: Aug. 26, 2019

(30) Foreign Application Priority Data
Sep. 19, 2018 (JP) 2018-174400

(51) Int. Cl. G03G 15/00; G03G 15/08

(52) U.S. Cl. CPC G03G 15/5041; G03G 15/0863

(57) ABSTRACT

Disclosed is an image forming apparatus including: an image forming unit which forms an image on a sheet; an abnormality detector which detects an image abnormality from the sheet on which the image is formed; and a hardware processor which, at the time of execution of a job, causes the image forming unit to form a test image for checking a detection level of the image abnormality by the abnormality detector, causes the abnormality detector to detect the image abnormality from the sheet on which the test image is formed, and performs an operation confirmation process of generating operation confirmation information of the abnormality detector on the basis of a detection result by the abnormality detector.

### CROSS REFERENCE TO RELATED APPLICATIONS

This application claims a priority under the Paris Convention of Japanese Patent Application No. 2018-174400 filed on Sep. 19, 2018, the entire disclosure of which is incorporated herein by reference in its entirety.

### TECHNOLOGICAL FIELD

The present invention relates to an image forming apparatus.

### DESCRIPTION OF THE RELATED ART

Conventionally, an image inspecting apparatus which forms an image on a sheet by an image forming apparatus such as a printer, a copier, and a printing press, and thereafter reads the image to detect an image abnormality such as a spot, a white void and a stripe is utilized. Additionally, there is an apparatus which intentionally forms a test image that simulates an image abnormality on a sheet in order to check whether or not a function of detecting the image abnormality is operating normally, and which is provided with a check mode for confirming whether or not the image abnormality can be detected from the test image.

For example, an inspection accuracy verification system which verifies inspection accuracy on the basis of defect detection data generated by inspecting a printed matter with a false defect printed thereon, and false defect data used for printing of a false defect is proposed (refer to JP 2008-003876A).

In an image inspecting system which inspects a read image obtained by reading an image formed and output, a technology of outputting an image falsely provided with defects, and determining a threshold value for determining the defects of the read image on the basis of a difference between a defect read image obtained by reading an output result, and a master image as a reference (JP 2014-044712A). The falsely provided defects are composed of a plurality of defects, defect levels (light and shade) of which are different in stages.

However, conventionally, determination as to whether or not a detecting function of an image abnormality is operating normally is performed in a case in which a check mode is designated. Therefore, even when an image abnormality detecting function is turned on at the time of execution of a job, in a case in which an image abnormality does not occur, an image abnormality is not detected, and it is not known whether or not the detection function is operating normally.

During the job, it cannot be confirmed which level of abnormality is detected.

### SUMMARY

The present invention has been made in order to solve a problem in the aforementioned conventional technology, and an object of the present invention is to enable operation confirmation of an image abnormality detecting function at the time of execution of a job.

To achieve at least one of the abovementioned objects, according to an aspect of the present invention, an image forming apparatus reflecting one aspect of the present invention includes:

an image forming unit which forms an image on a sheet;

an abnormality detector which detects an image abnormality from the sheet on which the image is formed; and

a hardware processor which, at the time of execution of a job, causes the image forming unit to form a test image for checking a detection level of the image abnormality by the abnormality detector, causes the abnormality detector to detect the image abnormality from the sheet on which the test image is formed, and performs an operation confirmation process of generating operation confirmation information of the abnormality detector on the basis of a detection result by the abnormality detector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic sectional view illustrating a whole configuration of an image forming apparatus according to a first embodiment of the present invention;

FIG. 2 is a block diagram illustrating a functional configuration of the image forming apparatus;

FIG. 3 is a flowchart illustrating a first job execution time process;

FIG. 4 is an example of a dedicated chart in which images for check are formed;

FIG. 5 is a diagram illustrating a definition example of a detection level of an image abnormality;

FIG. 6 is a display example of a current detection level;

FIG. 7 is an example of a detection report of an image abnormality;

FIG. 8 is a flowchart illustrating a second job execution time process executed by an image forming apparatus of a second embodiment;

FIG. 9 is a flowchart illustrating a third job execution time process executed by an image forming apparatus of a third embodiment;

FIG. 10 is an example of a sheet on which an image related to a job is formed and a test image thereon;

FIG. 11 is image data generated as operation confirmation information;

FIG. 12 is a flowchart illustrating a job execution time process according to a modification of the third embodiment;

FIG. 13 is a flowchart illustrating a fourth job execution time process executed by an image forming apparatus of a fourth embodiment;

FIG. 14 is an example of a detailed chart in which second images for check are formed;

FIG. 15 is a flowchart illustrating a fifth job execution time process executed by an image forming apparatus of a fifth embodiment;

FIG. 16 is a flowchart illustrating a deterioration monitoring process of an image abnormality detecting function executed by an image forming apparatus of a sixth embodiment; and

FIG. 17 is an example of a sheet on which a test image is formed in each region.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

To begin with, a first embodiment of an image forming apparatus according to the present invention will be described. The present invention is not limited to an illustrated example.

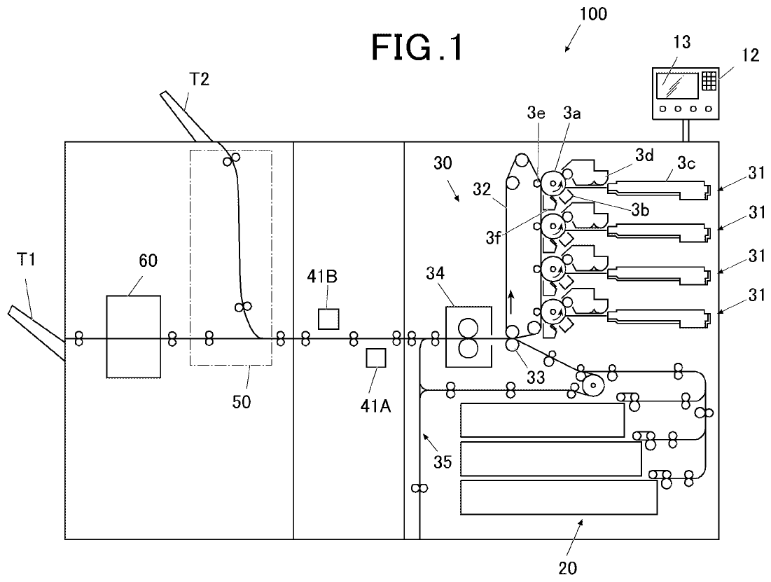

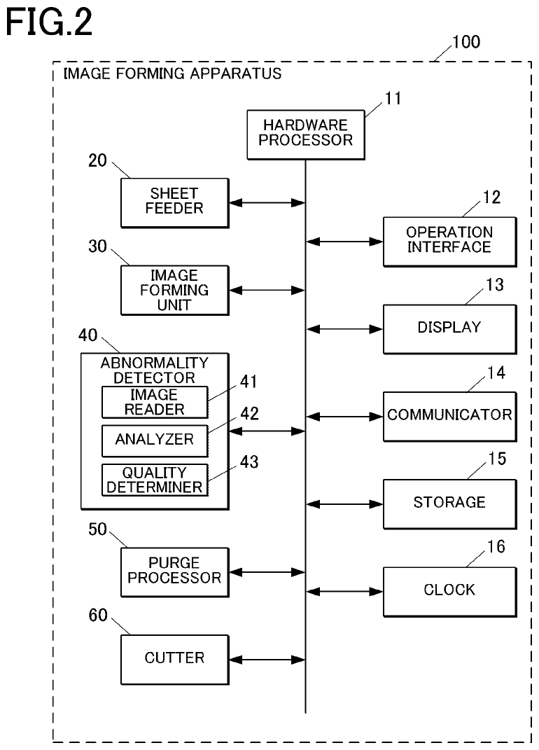

FIG. 1 is a schematic sectional view illustrating a whole configuration of an image forming apparatus 100. FIG. 2 is a block diagram illustrating a functional configuration of the image forming apparatus 100.

As illustrated in FIG. 2, the image forming apparatus 100 includes a hardware processor 11, an operation interface 12, a display 13, a communicator 14, a storage 15, a clock 16, a sheet feeder 20, an image forming unit 30, an abnormality detector 40, a purge processor 50, a cutter 60, and the like.

The hardware processor 11 includes a CPU (Central Processing Unit), a RAM (Random Access Memory), and the like, and controls each parts by reading out various programs from the storage 15 and executing the various programs.

As illustrated in FIG. 1, the operation interface 12 and the display 13 each are a user interface provided at an upper part of the image forming apparatus 100.

The operation interface 12 generates an operation signal in accordance with operation of a user, and outputs the operation signal to the hardware processor 11. A keypad, a touch panel integrally configured with the display 13, or the like can be used as the operation interface 12.

The display 13 displays an operation screen or the like in accordance with an instruction of the hardware processor 11. An LCD (Liquid Crystal Display), an OELD (Organic Electro Luminescence Display) or the like can be used as the display 13.

The communicator 14 transmits and receives data to and from an external apparatus connected to a communication network. For example, the communicator 14 receives data of a job as a target of image formation from the external apparatus.

The job is a series of operation related to image formation. For example, in a case in which a predetermined page of an output object is produced, a series of operation related to image formation of this output object is one job, and in a case in which a plurality of portions of an output object are produced, a series of operation related to image formation of the plurality of portions is one job. Data of the job includes image data per page, designation of a sheet (sheet type), single side/both side setting, setting of a cutting process (such as presence of cutting, and cutting width), the number of copies, and the like.

The storage 15 stores a program capable of reading by the hardware processor 11, data used at the time of execution of a program, and the like. A hard disk, a nonvolatile semiconductor storage, or the like can be used as the storage 15.

For example, image data of a test image is stored in the storage 15. The test image is an image for checking a detection level of an image abnormality by the abnormality detector 40. The test image includes an image simulating a plurality of stages (abnormality level) of an image abnormality. The storage 15 stores a position, a type, and an abnormality level (such as size and density) of the “image that simulates an image abnormality” in the test image.

The clock 16 has a clocking circuit (RTC: Real Time Clock), and this clocking circuit clocks current date and time to output the clocked current date and time to the hardware processor 11.

The sheet feeder 20 has a plurality of sheet feed trays each storing a sheet, and feeds the sheet from the sheet feed tray storing the sheet designated by a job to the image forming unit 30.

The image forming unit 30 forms an image composed of four colors of yellow, magenta, cyan and black in accordance with pixel values of four colors of each pixel of image data on a sheet. As illustrated in FIG. 1, the image forming unit 30 includes four writing units 31, an intermediate transfer belt 32, a secondary transfer roller 33, a fixing apparatus 34, and a reversing path 35.

The four writing units 31 are disposed in series (tandem) along a belt surface of the intermediate transfer belt 32, and forms an image of each color of yellow, magenta, cyan and black on the intermediate transfer belt 32. The writing units 31 have the same configuration except that colors of an image to be formed are different, and each includes a photoreceptor 3a, a charger 3b, an exposer 3c, a developer 3d, a primary transfer roller 3e, and a cleaner 3f, as illustrated in FIG. 1.

When an image is formed, in each writing unit 31, the photoreceptor 3a is charged by the charger 3b, and thereafter a surface of the photoreceptor 3a is scanned by luminous flux emitted by the exposer 3c on the basis of image data, and an electrostatic latent image is formed. When the developer 3d feeds coloring materials such as toner and performs development, an image is formed on the photoreceptor 3a.

The images formed on the photoreceptors 3a of the four writing units 31 are sequentially overlapped and transferred onto the intermediate transfer belt 32 by the respective primary transfer rollers 3e (primary transfer). Consequently, the images composed of respective colors are formed on the intermediate transfer belt 32. After the primary transfer, the cleaners 3f remove the coloring materials remaining on the photoreceptors 3a.

The image forming unit 30 transfers the images formed on the intermediate transfer belt 32 by the secondary transfer roller 33 onto a sheet fed from the sheet feeder 20 (secondary transfer), and thereafter the fixing apparatus 34 heats and pressurize the sheet to perform a fixing process.

In a case in which images are formed on both side of a sheet, after the sheet is conveyed to the reversing path 35 and front and back of the sheet are reversed, the sheet is conveyed to the secondary transfer roller 33 again.

The abnormality detector 40 detects an image abnormality from the sheet on which the images are formed. The image abnormality is not an image intended as a job, but means a spot (color point), a white void (outlined part), a stripe or the like that appears on an image. The spot is a part formed by adhering a coloring material such as toner onto an unintended portion. The white void is a part formed by blanking a portion of a part to be adhered by a coloring material such as toner. The stripe is a linear image abnormality, and a color stripe (stripe having higher density than a portion therearound), and a white stripe (stripe having lower density than a portion therearound). Additionally, there are a vertical stripe in the sheet conveying direction (FD: Feed Direction), a horizontal stripe in the sheet width direction (CD: Cross Direction), a stripe in the oblique direction, and the like. The abnormality detector 40 detects a density abnormality different from intended density, as the image abnormality.

The abnormality detector 40 includes an image reader 41, an analyzer 42, and a quality determiner 43.

The image reader 41 is disposed on a sheet conveyance route, and reads the sheet on which the images are formed by the image forming unit 30 to generate read image data. As the image reader 41, a line sensor in which sensors such as a CCD (Charge Coupled Device) and a CIS (Contact Image Sensor) are disposed one-dimensionally, an area sensor in which sensors such as a CCD (Charge Coupled Device) and a CIS (Contact Image Sensor) are disposed two-dimensionally, an image pickup device such as a camera, or the like can be used. As illustrated in FIG. 1, the image reader 41 includes an image reader 41A that reads a lower surface of a sheet conveyed from the image forming unit 30, and an image reader 41B that reads an upper surface of the sheet. In a case in which an image is formed on each of both sides of a sheet, both the image readers 41A, 41B are used. In a case in which an image is formed only on a single side, only the image reader 41B is simply used.

The analyzer 42 inspects the existence or absence of an image abnormality from the read image data generated by the image reader 41, and if an image abnormality exists, a position, a type, an abnormality level (degree of the abnormality) of the image abnormality and the like are output. More specifically, the analyzer 42 detects the image abnormality by comparing the read image data with reference image data in a state in which no image abnormality exists.

The quality determiner 43 determines quality of the detected image abnormality, on the basis of a preset user setting value (OK/NG boundary value). The user setting value is a boundary value used to determine the quality of the image abnormality, whether the image abnormality is permitted (OK), or is processed as damaged sheet (NG). The quality determiner 43 determines the image abnormality as NG (treated as an image abnormality) if the abnormality level of the image abnormality is the same as the user setting value, or the degree of the abnormality is larger than the user setting value. The quality determiner 43 determines the image abnormality as OK (not treated as an image abnormality), if the degree of the abnormality of the abnormality level of the image abnormality is smaller than the user setting value.

Processing contents of the analyzer 42 and the quality determiner 43 can be implemented by a hardware process using a processing circuit such as an ASIC (Application Specific Integrated Circuit) and a FPGA (Field-Programmable Gate Array), or can be implemented by a software process performed by reading a program by a processor such as a CPU and a GPU (Graphics Processing Unit).

A sheet after an image is formed is ejected to a sheet ejection tray T1 or a sheet ejection tray T2 illustrated in FIG. 1.

The purge processor 50 switches the sheet conveyance route in accordance with a destination of the sheet. For example, the purge processor 50 ejects a sheet on which an image is normally formed to the sheet ejection tray T1, and ejects, to the sheet ejection tray T2, a sheet determined to have an image abnormality, or a sheet (dedicated chart) on which only an test image is formed.

If the cutting process is set, the cutter 60 cuts a peripheral edge of a conveyed sheet at a preset position. The cutter 60 may cut a sheet one by one, or may cut a plurality of sheets in a lump.

The hardware processor 11 performs an operation confirmation process of causing the image forming unit 30 to form an test image for checking the detection level of an image abnormality by the abnormality detector 40, causing the abnormality detector 40 to detect the image abnormality with a sheet on which the test image is formed as a target, and generating operation confirmation information of the abnormality detector 40 on the basis of a detection result by the abnormality detector 40, at the time of execution of a job. The operation confirmation process includes the formation of the test image, the detection of an image abnormality, and the generation of the operation confirmation information.

The time of execution of a job includes at least one of timing of executing a job, job start time, during job, and job end time. The job start time is before job start, or at an early stage of a job (first page or the like). The job end time is after job end, or at a late stage of a job (last page or the like).

The detection level is a value indicating what extent the abnormality detector 40 (analyzer 42) can detect an image abnormality (detection limit). The detection level indicates at least one of the size and the density of an image abnormality.

The operation confirmation information includes information indicating that the abnormality detector 40 is operating normally, or a detection level at check time in the abnormality detector 40.

The hardware processor 11 determines what extent of an abnormality level of an image abnormality (detection level) of the abnormality detector 40 can detect on the basis of a position, a type, and an abnormality level of an image abnormality detected from an test image, and a position, a type, and an abnormality level of an image abnormality of the “image that simulates an image abnormality” stored in the storage 15. Among the image abnormality that can be detected by the abnormality detector 40, the abnormality level which is the most difficult to be detected is regarded as a current detection level. The hardware processor 11 determines whether or not the abnormality detector 40 can detect an image abnormality of an abnormality level (size, density) equivalent to the user setting value from the test image. If the current detection level is a level which enables detection of the image abnormality of the abnormality level equivalent to the user setting value, the hardware processor 11 determines that the abnormality detector 40 is operating normally. That is, the detection level is checked, so that whether or not the abnormality detector 40 is operating normally is found. Thus, the test image is also utilized to check that the abnormality detector 40 is operating normally.

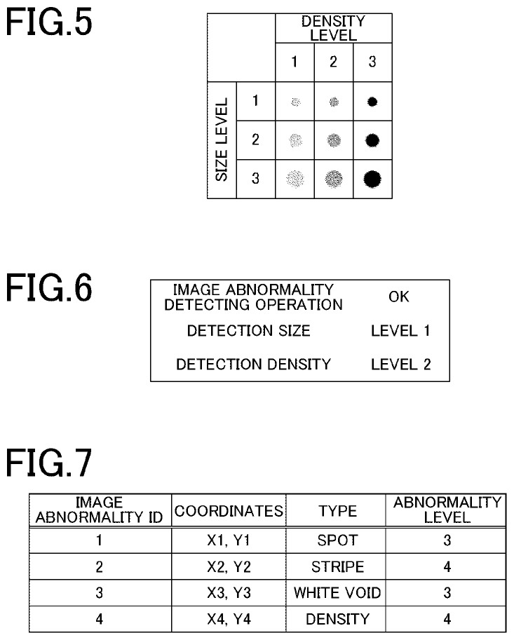

The hardware processor 11 generates, for example, information indicating that the abnormality detector 40 is operating normally, or text data including a detection level at check time in the abnormality detector 40, as the operation confirmation information (refer to FIG. 6).

The hardware processor 11 associates the operation confirmation information with information enabling identification of a job (hereinafter referred to as job identification information), and stores the associated operation confirmation information in the storage 15. The job identification information is, for example, a file name of a file related to a job, and image formation date and time of a job. As to the image formation date and time of a job, the hardware processor 11 acquires current date and time from the clock 16 at the time of execution of the job (job end time or the like).

The hardware processor 11 associates the operation confirmation information with a detection result of an image abnormality with respect to the job, and stores the associated operation confirmation information in the storage 15. The detection result of the image abnormality with respect to the job includes, for example, the existence or absence of the image abnormality, the number of detection of the image abnormality, and the like.

If the hardware processor 11 notifies the operation confirmation information, and acquires a user input of approval, the hardware processor 11 causes the image forming unit 30 to continue execution of a job.

Now, operation in the image forming apparatus 100 will be described.

### <Preparing Process>

Prior to a preparing process, blank sheet data for being compared with read image data obtained from a sheet on which an test image is formed is previously generated, and stored in the storage 15. The blank sheet data is read image data generated by reading a sheet on which no image is formed by the image reader 41.

In the preparing process, the hardware processor 11 causes the image forming unit 30 to form the test image, causes the abnormality detector 40 to detect an image abnormality with a sheet on which the test image is formed as a target, and notifies a user of a current detection level. More specifically, the hardware processor 11 displays the current detection level on the display 13.

The user confirms the notified current detection level, and sets a user setting value (OK/NG boundary value) used for quality determination of the image abnormality. The user designates the user setting value from the operation interface 12, and the hardware processor 11 causes the storage 15 to store the user setting value designated by the user.

Next, the hardware processor 11 causes the image forming unit 30 to form a portion of an image related to a job, and causes the image reader 41 to read an image with a series of sheets on which the image related to the job is formed as a target, and to generate read image data for a single job. This read image data is reference image data (normal image) used when the image abnormality is detected by the analyzer 42.

### <First Job Execution Time Process>

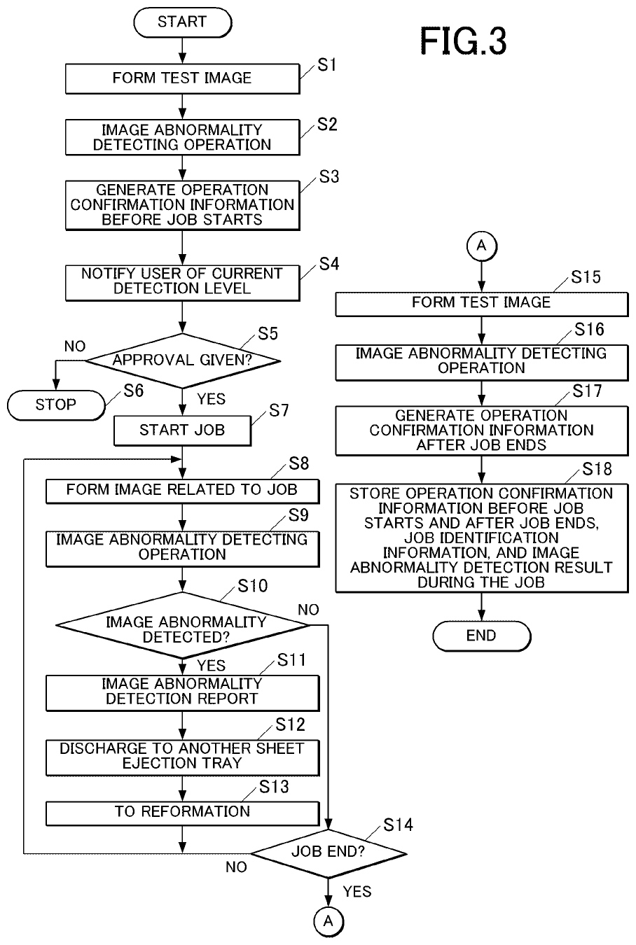

FIG. 3 is a flowchart illustrating a first job execution time process executed by the image forming apparatus 100. The first job execution time process is a process of notifying a user of a current detection level before starting a job, and starting the job after the user approves.

First, the hardware processor 11 reads out image data for a test image from the storage 15, and causes the image forming unit 30 to form a test image on the basis of the image data for the test image (Step S1). The first embodiment is an example of a case in which hardware processor 11 causes the image forming unit 30 to form the test image on a sheet different from the image related to the job (dedicated chart).

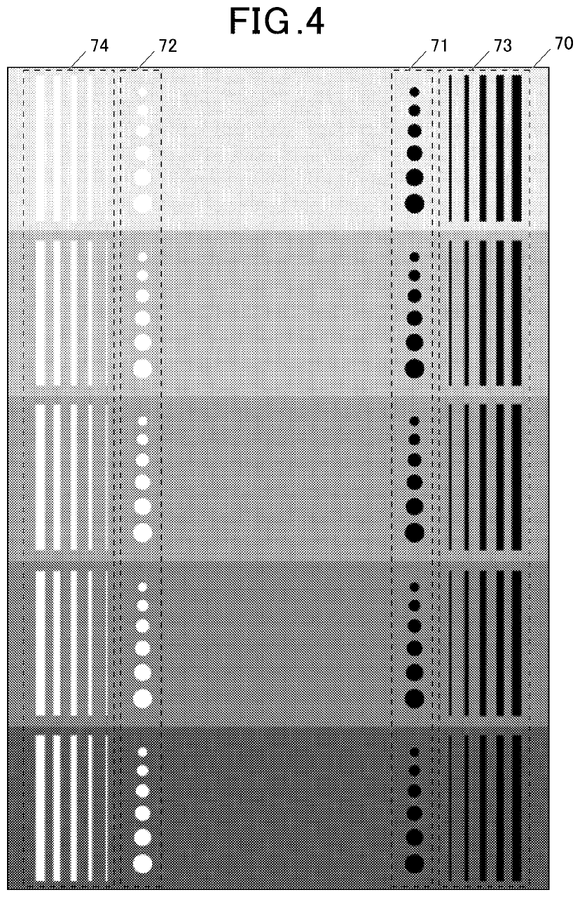

FIG. 4 illustrates an example of a sheet (dedicated chart 70) on which the images for check are formed. The dedicated chart 70 includes an image 71 which simulates spots, an image 72 which simulates white voids, an image 73 which simulates color stripes, and an image 74 which simulates white stripes. The image 71 which simulates the spots includes color points formed in a plurality of different sizes. The image 72 which simulates the white voids includes outlined part formed in a plurality of different sizes. The image 73 which simulates the color stripes, and the image 74 which simulates the white stripes include stripes formed with a plurality of respective different thicknesses.

The detection level of the image abnormality changes depending on background color or density, and therefore images that simulate various image abnormalities with respect to a plurality of backgrounds having different densities are formed in the dedicated chart 70.

The hardware processor 11 causes the abnormality detector 40 to execute the image abnormality detecting operation with the sheet on which the images for check are formed as a target (Step S2). More specifically, the image reader 41 reads the sheet on which the images for check are formed, and generates read image data. Then, the analyzer 42 compares blank sheet data with the read image data obtained from the sheet on which the images for check are formed, and detects an image abnormality. Like FIG. 4, if the images for check are formed on the background having a plurality of density regions, read image data generated by reading a sheet on which only the background is formed by the image reader 41 may be used as reference image data in place of the blank sheet data.

FIG. 5 illustrates a definition example of a detection level of an image abnormality (spot). As illustrated in FIG. 5, a size level is defined for each of a plurality of sizes, and a density level is defined with respect to each of a plurality of gradations of density. For example, if an image abnormality of size level “3” can be detected, but an image abnormality of size level “2” cannot be detected, the detection level in size is “3”.

The hardware processor 11 generates operation confirmation information of the abnormality detector 40 before job start, on the basis of a detection result by the abnormality detector 40 (Step S3). The operation confirmation information includes information indicating that the abnormality detector 40 is operating normally, a detection level at check time in the detector 40, and the like. More specifically, the hardware processor 11 determines a current detection level of the abnormality detector 40, on the basis of a position, a type, an abnormality level of the image abnormality detected from the images for check, and a position, a type, and an abnormality level of an image abnormality of the “image that simulates an image abnormality” stored in the storage 15. If the current detection level is a level which enables detection of the image abnormality of the abnormality level equivalent to the user setting value, the hardware processor 11 determines that the abnormality detector 40 is operating normally.

The hardware processor 11 causes the purge processor 50 to eject the sheet on which the images for check are formed to the sheet ejection tray T2 different from the normal sheet ejection tray.

The hardware processor 11 notifies the user of the current detection level obtained by analysis of the read image data of the sheet on which the images for check are formed (Step S4). More specifically, the hardware processor 11 displays the current detection level on the display 13.

FIG. 6 is a display example of the current detection level displayed on the display 13 on the basis of the operation confirmation information (text data) generated in Step S3. In FIG. 6, it is displayed that detection operation of the image abnormality by the abnormality detector 40 is normal (OK), detection size (detection level in size) of the image abnormality is “level 1”, and detection density (detection level in density) of the image abnormality is “level 2”

The user confirms the notified current detection level. The hardware processor 11 determines whether or not an instruction to approve execution of the job at the current detection level is given by operation from the operation interface 12 by the user (Step S5).

If the instruction to approve execution of the job at the current detection level is not given (Step S5; NO), the hardware processor 11 stops the image forming apparatus 100 (Step S6). The user performs maintenance such as cleaning of a reading sensor of the image reader 41 as necessary.

If the instruction to approve execution of the job at the current detection level is given in Step S5 (Step S5; YES), the hardware processor 11 starts a job (Step S7).

The hardware processor 11 causes the image forming unit 30 to form the image related to the job per page (Step S8).

The hardware processor 11 causes the abnormality detector 40 to execute the image abnormality detecting operation with the sheet on which the images related to a job are formed as a target (Step S9). More specifically, the image reader 41 reads the sheet on which the images related to the job are formed, and generates read image data. The analyzer 42 compares a corresponding page portion of reference image data of the job generated in the preparing process with the read image data newly generated by the image reader 41, and detects an image abnormality. The quality determiner 43 compares the abnormality level of the detected image abnormality with the user setting value, and determines quality of the image abnormality.

The hardware processor 11 determines whether or not the image abnormality is detected from the sheet on which the image related to the job is formed (Step S10). Herein, the “image abnormality is detected” means a case in which the abnormality detector 40 detects an image abnormality, and the abnormality level of the detected image abnormality is compared with the user setting value to be determined as NG.

If the image abnormality is detected (Step S10; YES), the hardware processor 11 generates a detection report of the image abnormality detected from the sheet on which the image related to the job is formed (Step S11). The detection report of the image abnormality includes detection of the image abnormality, the number of detection, a position, type, an abnormality level, and the like.

FIG. 7 illustrates an example of the detection report of the image abnormality. The detection report of the image abnormality includes an image abnormality ID, coordinates, a type, an abnormality level, and the like. The image abnormality ID is identification information imparted to the image abnormality detected from the read image data. The coordinates are coordinates indicating a position (such as a center location and the center of gravity of each image abnormality) of each image abnormality. The type is the type of each image abnormality. The abnormality level is information indicating the degree of each abnormality. The “density” in the “type” of FIG. 7 means a density abnormality different from intended density. As to a stripe, a color stripe/white stripe, and the direction of a stripe (vertical stripe/horizontal stripe) may be distinguished.

The hardware processor 11 causes the purge processor 50 to eject the sheet on which the image abnormality is detected, to the sheet ejection tray T2 different from the normal sheet ejection tray (Step S12). The hardware processor 11 returns to Step S8 in order to form again the image formed on the sheet on which the image abnormality is detected, (Step S13). The hardware processor 11 performs again image formation for the image corresponding to the sheet on which the image abnormality is detected.

Normally, image formation is continuously performed, and therefore output order in reformation per sheet is not limited to an example of the processes in the flowchart.

In Step S10, if no image abnormality is detected (Step S10; NO), the hardware processor 11 determines whether or not the job is ended (Step S14).

If the job is not ended (Step S14; NO), the process returns to Step S8, and is repeatedly performed with a next page as a target.

If the job is ended in Step S14 (Step S14; YES), the hardware processor 11 causes the cutter 60 to perform a cutting process for the sheet, and ejects the sheet on which the image related to the job is formed to the normal sheet ejection tray T1, as necessary.

The hardware processor 11 reads out image data for a test image from the storage 15, and causes the image forming unit 30 to form the test image on the basis of image data of the test image (Step S15).

The hardware processor 11 causes the abnormality detector 40 to execute the image abnormality detecting operation with the sheet on which the images for check are formed as a target (Step S16). Details of the image abnormality detecting operation are similar to those in Step S2.

The hardware processor 11 generates operation confirmation information of the abnormality detector 40 after job end on the basis of a detection result by the abnormality detector 40 (Step S17). Details of the generation of the operation confirmation information are similar to those in Step S3.

The hardware processor 11 causes the purge processor 50 to eject the sheet on which the images for check are formed to the sheet ejection tray T2 different from the normal sheet ejection tray.

The hardware processor 11 associates the operation confirmation information before job start, the operation confirmation information after job end, the job identification information (such as a file name and image formation date and time), and the image abnormality detection result during the job (image abnormality detection report generated for each page) and stores the these pieces of information as a long file in the storage 15 (Step S18).

Thus, the first job execution time process ends.

For example, the hardware processor 11 displays, on the display 13, the operation confirmation information before job start, the operation confirmation information after job end, the job identification information, and the image abnormality detection result during the job, which are stored in the storage 15, so that a user is notified.

The hardware processor 11 may transmit an e-mail including the operation confirmation information before job start, the operation confirmation information after job end, the job identification information, and the image abnormality detection result during the job to a previously designated mail address through the communicator 14.

The hardware processor 11 stores the operation confirmation information before job start, the operation confirmation information after job end, the job identification information, and the image abnormality detection result during the job in a storage medium. The user delivers the storage medium to a client who requests the job, together with the output object (sheet). Alternatively, the hardware processor 11 may transmit the e-mail including the operation confirmation information before job start, the operation confirmation information after job end, the job identification information, and the image abnormality detection result during the job to a mail address of the client who requests the job, through the communicator 14.

As described above, according to the first embodiment, at the time of execution of the job, formation of the images for check, detection of the image abnormality, and generation of the operation confirmation information are performed, and therefore it is possible to confirm the operation of an image abnormality detecting function at the time of execution of the job.

For example, information indicating that the abnormality detector 40 is operating normally, and operation confirmation information including a detection level at check time in the abnormality detector 40 can be generated, operation confirmation information at the time of execution of a job can be notified, or stored. Consequently, it is possible to present a fact that the abnormality detector 40 is operating normally at the time of execution of the job, or present a detection level at the time of execution of the job.

The operation confirmation information is associated with the job identification information to be stored in the storage 15, and therefore it is possible to leave evidence that the image abnormality detecting operation is performed with respect to the job. The user can deliver the operation confirmation information (electronic data) generated at the time of execution of the job to a client who requests the job, together with the output object.

The operation confirmation information is associated with the detection result of the image abnormality with respect to the job to be stored in the storage 15, and therefore it is possible to leave the detection result of the image abnormality during the job as evidence that the image abnormality detecting operation is performed.

In the first embodiment, the operation confirmation process is performed before job start, and the operation confirmation information is notified, and a user can select whether or not continuation of execution of the job is approved.

If there are a plurality of the sheet types to be used in the job, in Step S1 to Step S3, and Step S15 to Step S17, the hardware processor 11 performs the operation confirmation process (formation of a test image, detection of an image abnormality, generation of operation confirmation information) per each sheet type to be used in the job. Management of information such as the operation confirmation information is also performed per sheet type.

If the image abnormality is not detected in Step S10 (Step S10; NO), a report that the image abnormality is not detected may be left.

### Second Embodiment

Now, a second embodiment to which the present invention is applied will be described.

An image forming apparatus according to the second embodiment has the same configuration as the image forming apparatus 100 described in the first embodiment, and therefore description of common portions will be omitted by using FIG. 1 and FIG. 2. Hereinafter, characteristic configurations and processes in the second embodiment will be described.

A hardware processor 11 performs an operation confirmation process (formation of a test image, detection of an image abnormality, generation of operation confirmation information) at least at job start and at job end.

If an abnormality detector 40 detects an image abnormality other than a test image on a sheet on which the test image is formed, the hardware processor 11 notifies a user that the image abnormality is detected, and causes the user to select whether or not execution of a job is continued.

Now, operation by the image forming apparatus of the second embodiment will be described.

A preparing process is similar to that of the first embodiment.

### <Second Job Execution Time Process>

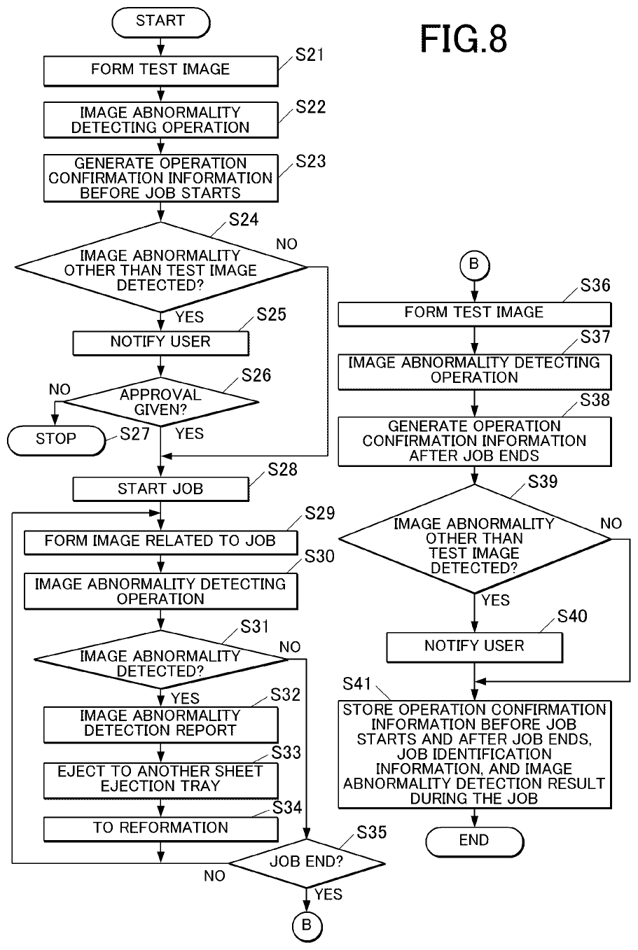

FIG. 8 is a flowchart illustrating a second job execution time process executed by the image forming apparatus of the second embodiment. The second job execution time process is a process of performing an operation confirmation process before job start and after job end.

Processes of Step S21 to Step S23 are similar to the processes of Step S1 to Step S3 of the first job execution time process (refer to FIG. 3), and therefore description thereof will be omitted.

The hardware processor 11 causes the abnormality detector 40 to determine whether or not the image abnormality other than the test image is detected, from the sheet on which the test image is formed before job start, in image abnormality detecting operation of Step S22 (Step S24). Herein, the “image abnormality other than the test image is detected” is a case in which the abnormality detector 40 detects the image abnormality other than the test image, and further determines that an abnormality level of the detected image abnormality is NG by comparison with a user setting value.

If the image abnormality other than the test image is detected from the sheet on which the test image is formed (Step S24; YES), the hardware processor 11 notifies the user of information related to this image abnormality (Step S25). For example, the hardware processor 11 displays a position, a type, an abnormality level, and the like of the detected image abnormality (image abnormality other than the test image) on a display 13.

The user confirms the notified information related to the image abnormality. The hardware processor 11 determines whether or not an instruction to approve execution of the job in such a state is given by operation from an operation interface 12 by the user (Step S26).

If the instruction to approve execution of the job is not given (Step S26; NO), the hardware processor 11 stops the image forming apparatus (Step S27). The user performs maintenance such as cleaning of a reading sensor of an image reader 41 as necessary.

If the instruction to approve execution of the job is given in Step S26 (Step S26; YES), or if the image abnormality other than the test image is not detected from the sheet on which the test image is formed in Step S24 (Step S24; NO), the hardware processor 11 starts the job (Step S28).

Processes of Step S29 to Step S38 are similar to the processes of Step S8 to Step S17 of the first job execution time process (refer to FIG. 3), and therefore description will be omitted.

The hardware processor 11 causes the abnormality detector 40 to determine whether or not image abnormality other than the test image is detected from the sheet on which the test image is formed after job end, in image abnormality detecting operation of Step S37 (Step S39). Details of the determination are similar to those of Step S24.

If the image abnormality other than the test image is detected from the sheet on which the test image is formed (Step S39; YES), the hardware processor 11 notifies the user of information related to this image abnormality (Step S40).

If the image abnormality other than the test image is not detected from the sheet on which the test image is formed after Step S40 or in Step S39 (Step S39; NO), the hardware processor 11 associates the operation confirmation information before job start, the operation confirmation information after job end, the job identification information, and the image abnormality detection result during the job, and stores these pieces of information in the storage 15 (Step S41).

Thus, the second job execution time process ends.

As described above, according to the second embodiment, the operation confirmation process is performed at job start and at job end, and therefore it is possible to confirm the operation of an image abnormality detecting function at the time of execution of the job. The user can deliver the operation confirmation information generated at the time of execution of the job to a client, together with an output object.

If the abnormality detector 40 detects the image abnormality from a portion other than the test image on the sheet on which the test image is formed, the user is notified, and selects whether or not execution of the job is continued, and therefore the user can select that the image abnormality is permitted, or that maintenance such as cleaning is performed.

If the image abnormality other than the test image is detected in Step S24 (Step S24; YES), a fact that the image abnormality other than the test image is detect, and information related to the image abnormality other than the test image may be stored in the storage 15 without temporarily stopping, in place of the processes of Step S25 and Step S26.

Similarly, if the image abnormality other than the test image is detected in Step S39 (Step S39; YES), a fact that the image abnormality other than the test image is detected, and the information related to the image abnormality other than the test image may be stored in the storage 15, in place of the process of Step S40.

The processes of Step S21 to Step S27 may be performed during the job. More specifically, if the operation confirmation process is performed, and the abnormality detector 40 detects the image abnormality from a portion other than the test image on the sheet on which the test image is formed, the user may be notified, and may select whether execution of the job is continued or stopped.

### Third Embodiment

Now, a third embodiment to which the present invention is applied will be described.

An image forming apparatus according to the third embodiment has the same configuration as the image forming apparatus 100 described in the first embodiment, and therefore description of common portions will be omitted by using FIG. 1 and FIG. 2. Hereinafter, characteristic configurations and processes in the third embodiment will be described.

A hardware processor 11 causes an image forming unit 30 to form test images in trimming regions (end regions of a sheet to be trimmed by a cutter 60) of a sheet on which an image related to a job is formed, and generates operation confirmation information per page.

The hardware processor 11 generates image data obtained by adding marks indicating detection portions of image abnormalities to image data obtained by reading a sheet on which the images for check are formed, as operation confirmation information (refer to FIG. 11).

The hardware processor 11 ejects, to a sheet ejection tray T2 different from a normal sheet ejection tray T1, a sheet, an image abnormality on which is detected by an abnormality detector 40, and causes the image forming unit 30 to form again an image corresponding to a sheet on which the image abnormality is detected, on a sheet different from the sheet on which the image abnormality is detected (principle).

If the abnormality detector 40 detects an image abnormality from a portion other than the images for check, in the trimming regions of the sheet on which the images for check are formed, as an exception, the hardware processor 11 causes the image forming unit 30 to continue execution of the job without discharging the sheet on which the images for check are formed to the sheet ejection tray T2 different from a normal sheet ejection tray T1, and forming again the image corresponding to the sheet on which the image abnormality is detected, on a sheet different from the sheet on which the image abnormality is detected.

Now, operation by the image forming apparatus of the third embodiment will be described.

A preparing process is similar to that of the first embodiment.

### <Third Job Execution Time Process>

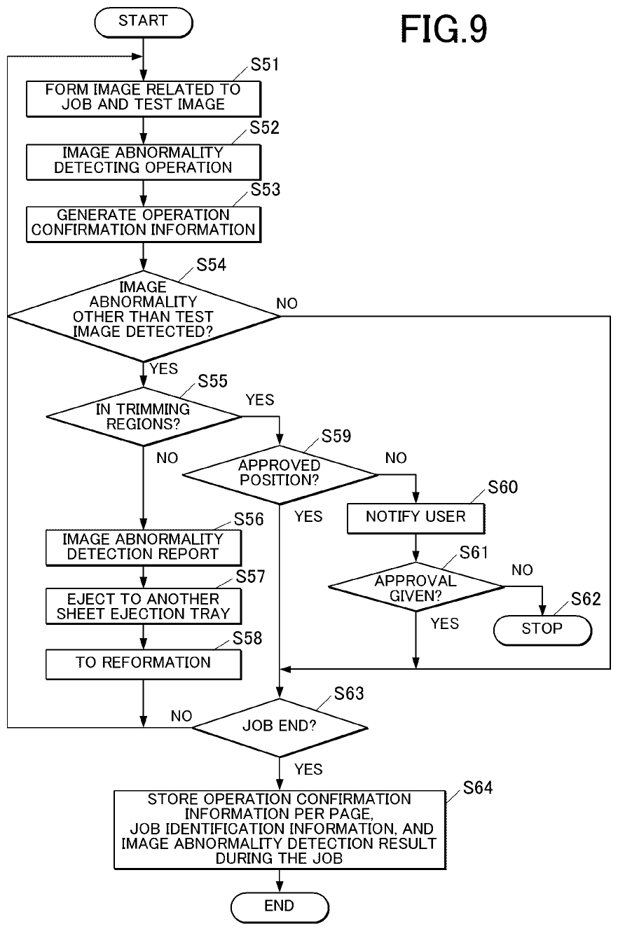

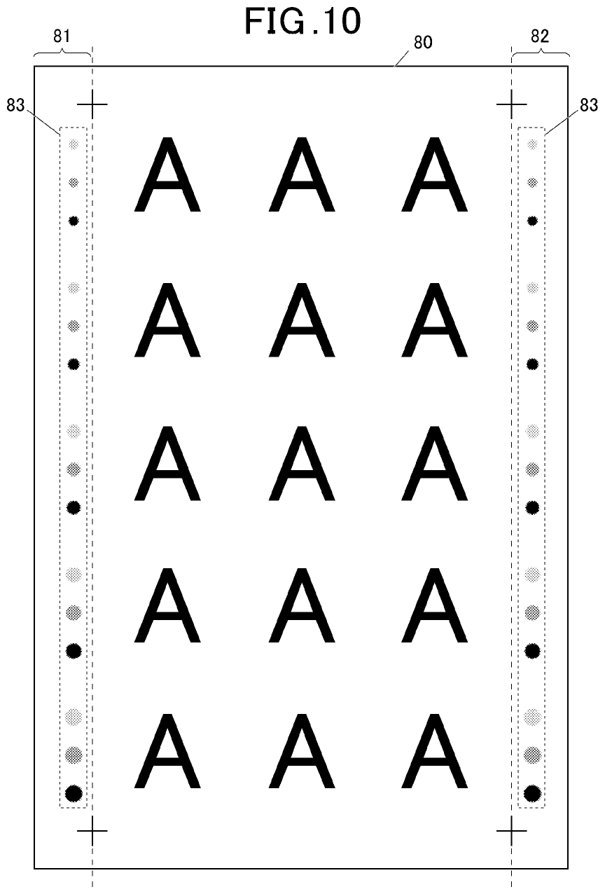

FIG. 9 is a flowchart illustrating a third job execution time process executed by the image forming apparatus of the third embodiment. The third job execution time process is a process of performing an operation confirmation process per page.

The hardware processor 11 causes the image forming unit 30 to form an image related to a job, and images for check per page (Step S51). At this time, the hardware processor 11 forms the images for check in the trimming regions of the sheet on which the image related to the job is formed.

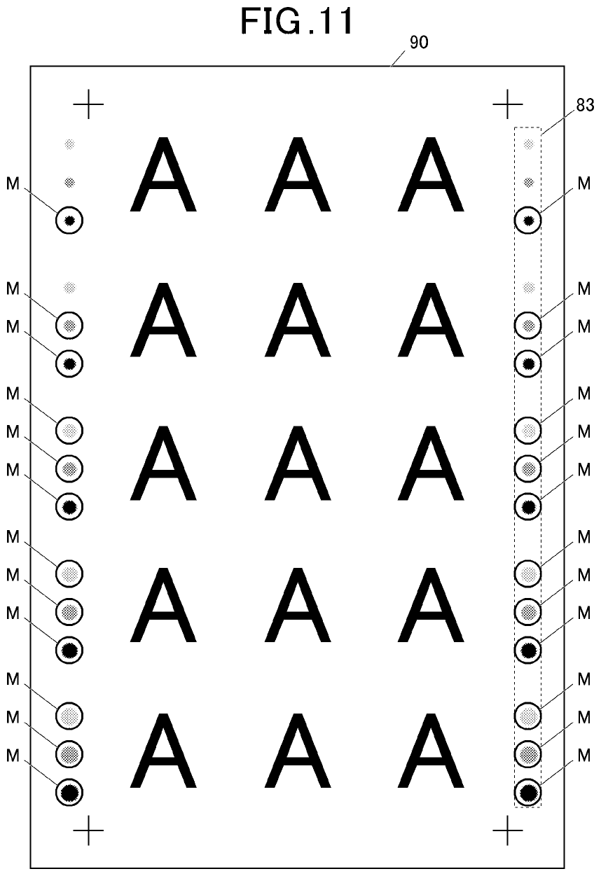

FIG. 10 is an example of a sheet 80 on which the image related to the job is formed and the images for check thereon. The image related to the job is formed in a central region of the sheet 80, and images 83 which simulate spots are formed in trimming regions 81, 82. The images 83 which simulate spots each include color points formed in a plurality of different sizes, and a plurality of different densities.

The hardware processor 11 causes the abnormality detector 40 to execute image abnormality detecting operation with the sheet on which the image related to the job is formed and the images for check thereon as a target (Step S52). More specifically, an image reader 41 reads the sheet on which the image related to the job is formed and the images for check thereon, and generates read image data. An analyzer 42 compares a corresponding page portion of reference image data of the job generated in the preparing process with the read image data newly generated by the image reader 41, and detects an image abnormality. A quality determiner 43 compares the abnormality level of the detected image abnormality with a user setting value, and determines quality of the image abnormality.

The hardware processor 11 generates operation confirmation information of the abnormality detector 40 on the basis of a detection result for the images for check by the abnormality detector 40 (all image abnormalities detected by the analyzer 42) (Step S53). More specifically, the hardware processor 11 determines a current detection level of the abnormality detector 40 on the basis of the detection result for the images for check. The hardware processor 11 determines whether or not the abnormality detector 40 is operating normally.

FIG. 11 is image data 90 generated as the operation confirmation information. The image data 90 adds marks M indicating detection portions of image abnormalities to the image data obtained by reading the sheet on which the images for check are formed (refer to FIG. 10). The image data 90 generates in a file format such as PDF (Portable Document Format). The image data 90 is confirmed, so that what extent of size and what extent of density of the “image which simulates image abnormality” can be detected among the images for check (detection level) can be grasped.

The hardware processor 11 causes the abnormality detector 40 to determine whether or not the image abnormality other than the images for check is detected, in image abnormality detecting operation of Step S52 (Step S54). Herein, the “image abnormality other than the images for check is detected” is a case in which the abnormality detector 40 detects the image abnormality other than the images for check, and further determines that an abnormality level of the detected image abnormality is NG by comparison with the user setting value.

If the image abnormality other than the images for check is detected (Step S54; YES), the hardware processor 11 determines whether or not the detected image abnormality is in the trimming regions (Step S55).

If the detected image abnormality is not in the trimming regions (Step S55; NO), that is, if the image abnormality exists in the region to be used as the output object of the job, the hardware processor 11 generates a detection report of an image abnormality (Step S56).

The hardware processor 11 causes the purge processor 50 to eject a sheet on which the image abnormality is detected, to the sheet ejection tray T2 different from the normal sheet ejection tray (Step S57). The hardware processor 11 returns to Step S51 in order to form again the image formed on the sheet on which the image abnormality is detected, (Step S58). The hardware processor 11 performs again image formation for an image corresponding to the sheet on which the image abnormality is detected.

If the detected image abnormality is in the trimming regions in Step S55 (Step S55; YES), that is, if the image abnormality exists in the region where there is no problem as the output object of the job, the hardware processor 11 determines whether or not the position of the detected image abnormality is a position already approved by the user (Step S59). More specifically, the hardware processor 11 determines whether or not the position of the image abnormality detected at this time is already approved with reference to the already approved position stored in the storage 15.

If the position of the detected image abnormality is a position unapproved by the user (Step S59; NO), the hardware processor 11 notifies the user of information related to this image abnormality (Step S60). For example, the hardware processor 11 displays the position, the type, the abnormality level, and the like of the detected image abnormality on the display 13.

The user confirms the notified information related to the image abnormality. The hardware processor 11 determines whether or not an instruction to approve continuation of execution of the job at such a state is given by operation from the operation interface 12 by the user (Step S61).

If the instruction to approve continuation of execution of the job is not given (Step S61; NO), the hardware processor 11 stops the image forming apparatus (Step S62). The user performs maintenance such as cleaning of a reading sensor of the image reader 41.

If the instruction to approve continuation of execution of the job is given in Step S61 (Step S61; YES), the hardware processor 11 stores the position of the image abnormality approved by the user in the storage 15, and shifts the process to Step S63.

If the position of the detected image abnormality is a position already approved by the user in Step S59 (Step S59; YES), that is, if operation for the instruction to be approved by the user is performed for a position of this image abnormality until now, and the position is stored in the storage 15, the process is shifted to Step S63.

If the abnormality detector 40 does not detect the image abnormality other than the test image in Step S54 (Step S54; NO), the process is shifted to Step S63.

In Step S63, the hardware processor 11 determines whether or not the job ends (Step S63).

If the job does not end (Step S63; NO), the process returns to Step S51, and repeatedly performed with a next page as a target.

If the job ends in Step S63 (Step S63; YES), the hardware processor 11 causes the cutter 60 to perform a cutting process for a sheet, and a sheet on which the image related to the job is formed is ejected to the normal sheet ejection tray T1.

The hardware processor 11 associates the operation confirmation information per page, the job identification information, and the image abnormality detection result during the job (image abnormality detection report generated for each page), and stores these pieces of information in the storage 15 (Step S64).

Thus, the third job execution time process ends.

As described above, according to the third embodiment, formation of the images for check, detection of the image abnormality, generation of the operation confirmation information are performed per page at the time of execution of the job, and therefore it is possible to confirm the operation of an image abnormality detecting function at the time of execution of the job. The user can deliver, to a client, the operation confirmation information generated at the time of execution of the job, together with the output object.

If the image abnormality is detected from a portion other than the images for check in the trimming regions of the sheet on which the images for check are formed, there is no problem as the output object of the job, and therefore it is possible to omit ejection to the sheet ejection tray T2 different from the normal sheet ejection tray T1, or omit reformation of the image.

Although the images for check are formed for all pages in the third job execution time process, the formation of images for check may be performed at a predetermined interval such as once per several pages.

### Modification

Now, a modification of the third embodiment will be described.

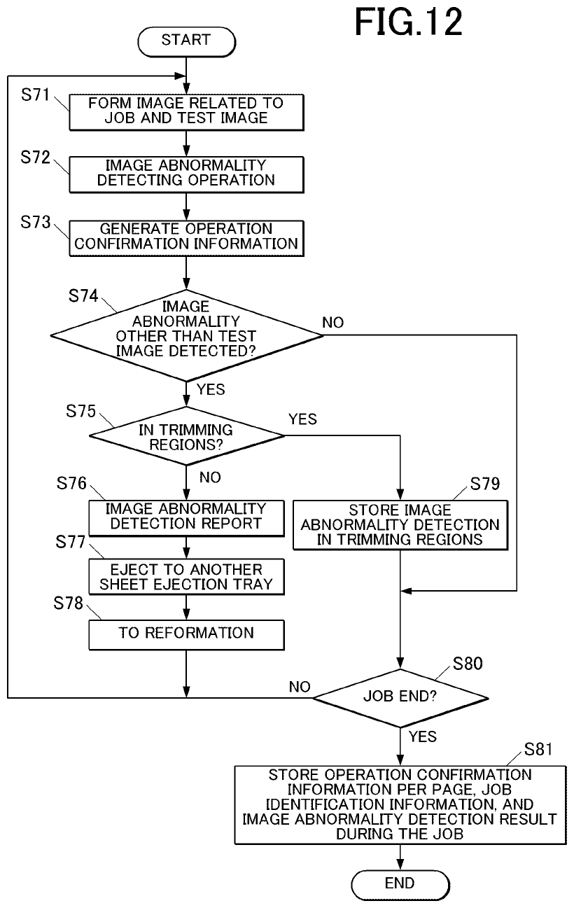

FIG. 12 is a flowchart illustrating a job execution time process in a modification.

Processes of Step S71 to Step S78 are similar to the processes of Step S51 to Step S58 of the third job execution time process (refer to FIG. 9), and therefore description thereof will be omitted.

If the detected image abnormality (image abnormality other than the images for check) is in the trimming regions in Step S75 (Step S75; YES), that is, if the image abnormality exists in the region where there is no problem as the output object of the job, the fact that the hardware processor 11 detects the image abnormality other than the images for check in the trimming regions, and information related to the image abnormality other than the images for check are stored in the storage 15 (Step S79). For example, the hardware processor 11 stores the position, the type, the abnormality level, and the like of the detected image abnormality.

If the abnormality detector 40 does not detect the image abnormality other than the images for check after Step S79 or in Step S74 (Step S74; NO), the process is shifted to Step S80.

Processes of Step S80 to Step S81 are similar to the processes of Step S63 to Step S64 of the third job execution time process (refer to FIG. 9), and therefore description thereof will be omitted.

Thus, the job execution time process in the modification ends.

According to the modification, if the image abnormality is detected from the portion other than the images for check in the trimming regions of the sheet on which the images for check are formed, detection of the image abnormality, and the information related to the image abnormality can be stored. Consequently, even the image abnormality in the region where there is no problem as the output object of the job can remain a detected history.

### Fourth Embodiment

Now, a fourth embodiment to which the present invention is applied will be described.

An image forming apparatus according to the fourth embodiment has the same configuration as the image forming apparatus 100 described in the first embodiment, and therefore description of common portions will be omitted by using FIG. 1 and FIG. 2. Hereinafter, characteristic configurations and processes in the fourth embodiment will be described.

If a detection level (detection limit) of an abnormality detector 40 becomes worse than a boundary value (user setting value) to be used for quality determination of an image abnormality preset by a user, during a job, the hardware processor 11 temporarily stops the job, and causes an image forming unit 30 to form second images for check for checking a detection level of an image abnormality by the abnormality detector 40 more specifically than the test image, causes the abnormality detector 40 to detect an image abnormality with a sheet on which the second images for check are formed as a target, and notifies a current detection level (high accuracy) obtained from the second images for check.

The phrase “worse than the user setting value” means that the abnormality detector 40 cannot detect the image abnormality at an abnormality level corresponding to the user setting value.

The second images for check may be the same as the test image formed in the dedicated chart in the first embodiment or the second embodiment.

Now, operation by the image forming apparatus of the fourth embodiment will be described.

A preparing process is similar to that of the first embodiment.

### <Fourth Job Execution Time Process>

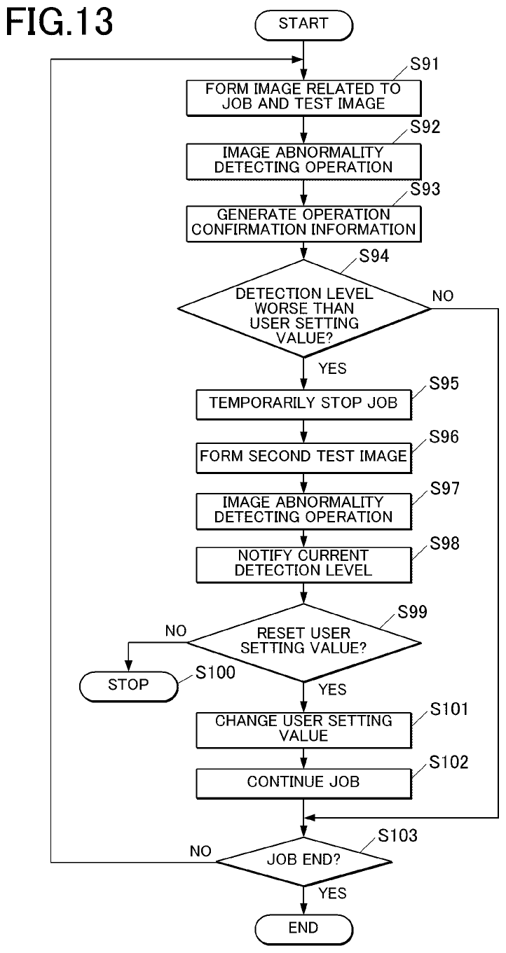

FIG. 13 is a flowchart illustrating a fourth job execution time process executed by the image forming apparatus of the fourth embodiment. The fourth job execution time process is a process of confirming whether an image abnormality detecting function operates during a job as set.

Processes of Step S91 to Step S93 are similar to the processes of Step S51 to Step S53 of the third job execution time process (refer to FIG. 9), and therefore description thereof will be omitted.

The hardware processor 11 determines whether or not the detection level of the abnormality detector 40 is worse than the user setting value obtained by the detection result for the test image in the image abnormality detecting operation of Step S92 (Step S94).

If the detection level of the abnormality detector 40 is worse than the user setting value (Step S94; YES), the hardware processor 11 temporarily stops the job (Step S95).

The hardware processor 11 reads out image data for the second images for check from a storage 15, and causes the image forming unit 30 to form the second images for check on the basis of the image data for the second images for check (Step S96).

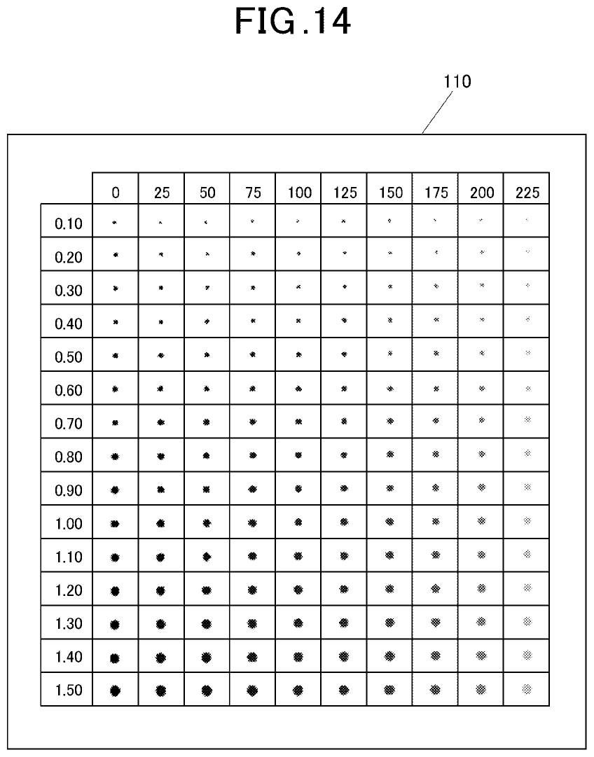

FIG. 14 is an example of the sheet on which the second images for check are formed (detailed chart 110). The detailed chart 110 is formed with images (color points) that simulate a plurality of spots with a plurality of different sizes, and a plurality of different densities. In FIG. 14, a plurality of color points with different sizes are disposed in the vertical direction, and a plurality of color points with different densities (tones) are disposed in the horizontal direction. Increments of the size and the density are finely taken, so that it is possible to perform check at a more detailed detection level.

The hardware processor 11 causes the abnormality detector 40 to execute image abnormality detecting operation with the sheet on which the second images for check are formed as a target (Step S97). More specifically, an image reader 41 reads the sheet on which the second images for check are formed, and generates read image data. Then, an analyzer 42 compares blank sheet data with the read image data obtained from the sheet on which the second images for check are formed, and detects an image abnormality. Like FIG. 14, in a case in which the second images for check are formed within a grid-shaped frame, read image data generated by reading a sheet on which a frame and numeral values (0.10 to 1.50, 0 to 225) are formed by the image reader 41 may be used as a reference image data in place with the blank sheet data.

The hardware processor 11 notifies the user of the current detection level (high accuracy) obtained by analysis of the read image data of the sheet on which the second images for check are formed (Step S98). More specifically, the hardware processor 11 displays the current detection level on the display 13.

The user confirms the notified current detection level, and determines whether or not a determination reference (user setting value) in the detection of the image abnormality is relaxed. That is, the user determines whether or not the user setting value is changed in a range in which the abnormality detector 40 can currently detect. The hardware processor 11 determines whether or not an instruction to reset the user setting value (OK/NG boundary value) is given by operation from an operation interface 12 by the user (Step S99).

If the instruction to reset the user setting value is not given (Step S99; NO), the hardware processor 11 stops the image forming apparatus (Step S100). The user performs maintenance such as cleaning of a reading sensor of the image reader 41 and component replacement.

If the instruction to reset the user setting value is given in Step S99 (Step S99; YES), the hardware processor 11 changes the user setting value on the basis of user operation (Step S101), and the job is continued (Step S102). After this, a quality determiner 43 determines OK/NG of the image abnormality with the changed user setting value as a reference.

After Step S102, or in Step S94, if the detection level of the abnormality detector 40 is the same as the user setting value or in a better state than the user setting value (Step S94; NO), the hardware processor 11 determines whether or not the job ends (Step S103).

The “same as the user setting value” means a state in which the abnormality detector 40 can detect an image abnormality of an abnormality level just equivalent to the user setting value.

The “better state than the user setting value” means a state in which the abnormality detector 40 can detect an image abnormality which is more difficult to be detected than the image abnormality of the abnormality level equivalent to the user setting value (a smaller image abnormality, an image abnormality having smaller density difference from the periphery thereof, or the like).

If the job is not ended (Step S103; NO), the process returns to Step S91, and is repeatedly performed with a next page as a target.

If the job is ended in Step S103 (Step S103; YES), the fourth job execution time process ends.

As described above, according to the fourth embodiment, if the detection level of the abnormality detector 40 is worse than the user setting value during the job, the current detection level which is checked by using a more specific second images for check is notified, and therefore the job can be continued after the user resets the user setting value. Alternatively, the detection level of the abnormality detector 40 can be improved by cleaning of the reading sensor of the image reader 41, component replacement, or the like.

If the image abnormality is detected from a region (region of the image related to the job) except the trimming regions in the image abnormality detecting operation of Step S92, and is determined as NG, the hardware processor 11 ejects, to a sheet ejection tray T2 different from a normal sheet ejection tray T1, a sheet on which the image abnormality is detected, and causes the image forming unit 30 to form again, on another paper, an image corresponding to the sheet on which the image abnormality is detected.

### Fifth Embodiment

Now, a fifth embodiment to which the present invention is applied will be described.

An image forming apparatus according to the fifth embodiment has the same configuration as the image forming apparatus 100 described in the first embodiment, and therefore description of common portions will be omitted by using FIG. 1 and FIG. 2. Hereinafter, characteristic configurations and processes in the fifth embodiment will be described.

If the number of detection of an image abnormality exceeds a predetermined number during a job, the hardware processor 11 temporarily stops the job, causes an image forming unit 30 to form third images for check for checking a detection level of an image abnormality by the abnormality detector 40 more specifically than the test image, causes the abnormality detector 40 to detect an image abnormality with a sheet on which the third images for check are formed as a target, and notifies a current detection level (high accuracy) obtained from the third images for check.

The third images for check may be configured by images similar to the second images for check image (refer to FIG. 14), or may be the same as the test image formed in the dedicated chart in the first embodiment or the second embodiment.

Now, operation by the image forming apparatus of the fifth embodiment will be described.

A preparing process is similar to that of the first embodiment.

### <Fifth Job Execution Time Process>

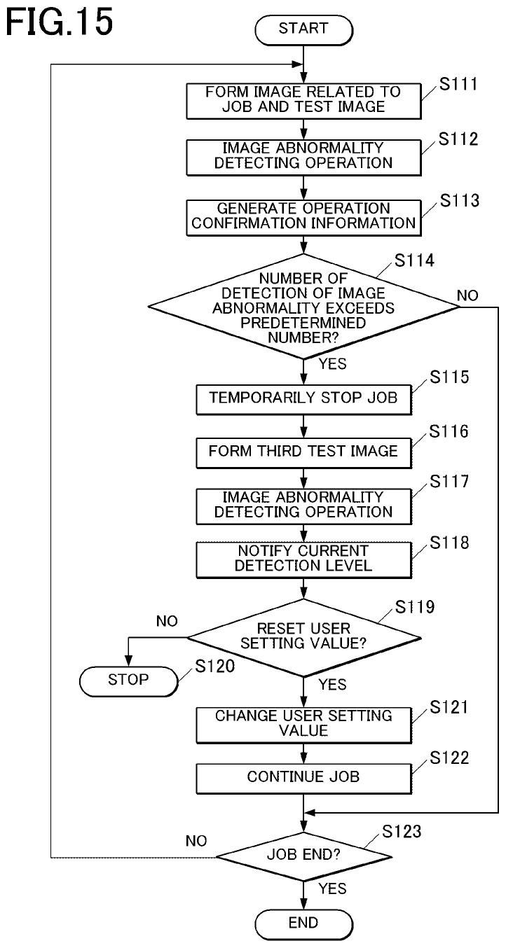

FIG. 15 is a flowchart illustrating a fifth job execution time process executed by the image forming apparatus of the fifth embodiment. The fifth job execution time process is a process of confirming an image reader 41 or the image forming unit 30 whether there is an abnormality, during the job.

Processes of Step S111 to Step S113 are similar to the processes of Step S91 to Step S93 of the fourth job execution time process (refer to FIG. 13), and therefore description thereof will be omitted.

The hardware processor 11 causes the abnormality detector 40 to determine whether or not the number of detection of the image abnormality (the number of determination as NG by a quality determiner 43) detected in Step S112 is exceeds the predetermined number (Step S114). Herein, as to the “number of detection of the image abnormality”, a detection range of the image abnormality used in comparison with the predetermined number may be a whole sheet, or may be limited to a region except trimming regions (region of an image related to the job). The “number of detection of the image abnormality” does not include the number of image abnormalities detected from the images for check (images which simulate the image abnormality).

If the number of detection of the image abnormality exceeds the predetermined number (Step S114; YES), the process is shifted to Step S115.

If the number of detection of the image abnormality is the predetermined number or less in Step S114 (Step S114; NO), the process is shifted to Step S123.

Processes of Step S115 to Step S123 are similar to processes in which the “second images for check” is replaced with the “third images for check” in the processes of Step S95 to Step S103 of the fourth job execution time process (refer to FIG. 13), and therefore description thereof will be omitted.

A user confirms a notified current detection level in Step S118, and determines whether or not a determination reference in the detection of the image abnormality is too strict. That is, the user determines whether or not a user setting value is changed so as to widen a permissible range of the image abnormality.

As described above, according to the fifth embodiment, if the number of detection of the image abnormality exceeds the predetermined number during the job, the current detection level which is checked by using a more specific third images for check is notified, and therefore the job can be continued after the user resets the user setting value. Alternatively, the detection level of the abnormality detector 40 can be improved by maintenance of the image reader 41, or the image forming unit 30.

Although it is determined whether or not the number of detection of the image abnormality detected in one page exceeds the predetermined number in Step S114, the number of detection of the image abnormality may be accumulated per page, and may be determined whether or not an accumulated value exceeds the predetermined number.

In the image abnormality detecting operation in Step S112, the image abnormality is detected from the region expect the trimming region (region of the image related to the job), and is determined as NG, the hardware processor 11 ejects, to the sheet ejection tray T2 different from the normal sheet ejection tray T1, the sheet on which the image abnormality is detected, and causes the image forming unit 30 to form again, on another sheet, the image corresponding to the sheet on which the image abnormality is detected.

### Sixth Embodiment

Now, a sixth embodiment to which the present invention is applied will be described.

An image forming apparatus according to the sixth embodiment has the same configuration as the image forming apparatus 100 described in the first embodiment, and therefore description of common portions will be omitted by using FIG. 1 and FIG. 2. Hereinafter, characteristic configurations and processes in the sixth embodiment will be described.

The hardware processor 11 stores a change amount of a detection level of an abnormality detector 40 at the start and at the end of a job in a storage 15 per job together with the number of image formations. If the change amount of the detection level with respect to the number of image formations is larger than a predetermined value, the hardware processor 11 notifies deterioration of the abnormality detector 40.

For example, when a reading function of a reading sensor of an image reader 41 is deteriorated, only a relatively large image abnormality, and an image abnormality having larger density difference from the periphery thereof can be detected.

Now, operation by the image forming apparatus of the sixth embodiment will be described.

### <Deterioration Monitoring Process of Image Abnormality Detecting Function>

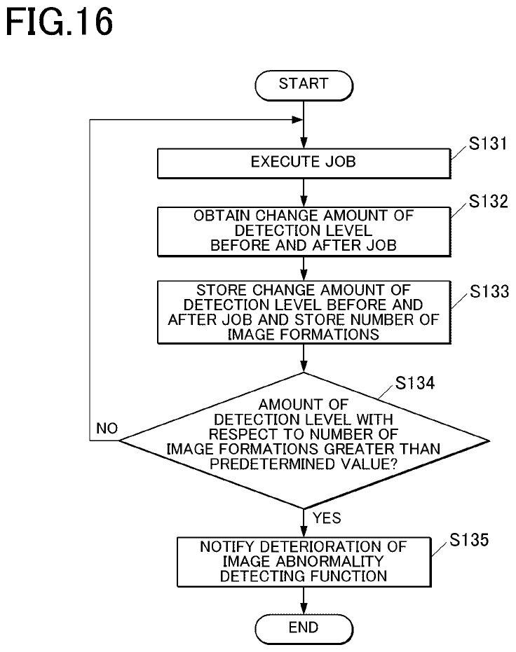

FIG. 16 is a flowchart illustrating a deterioration monitoring process of an image abnormality detecting function executed by the image forming apparatus of the sixth embodiment.

The hardware processor 11 executes a job (Step S131). An operation confirmation process accompanying the execution of the job is performed before the start of the job and after the end of the job, similarly to the first embodiment or the second embodiment.

The hardware processor 11 obtains the change amount of the detection level of the abnormality detector 40 before the start of the job and after the end of the job (Step S132).

The hardware processor 11 associates the change amounts of the detection levels at the start of the job and at the end of the job with the number of image formations in the job, and stores the above in the storage 15 (Step S133).

The hardware processor 11 determines whether or not the change amount of the detection level to the number of image formations is larger than the predetermined value in the job of this time (Step S134). The predetermined value may be a previously determined values, and may be a value set on the basis of the change amount of the detection level to the number of image formations collected in the job until now.

If the change amount of the detection level with respect to the number of image formations is a predetermined value or less (Step S134; NO), the process is shifted to Step S131, and the hardware processor 11 performs a process for a next job at execution timing of the next job.

If the change amount of the detection level with respect to the number of image formations is larger than the predetermined value in Step S134 (Step S134; YES), the hardware processor 11 notifies the deterioration of the image abnormality detecting function of the abnormality detector 40 by displaying the deterioration on a display 13, or the like (Step S135).

Thus, the deterioration monitoring process of the image abnormality detecting function ends.

In Step S135, the deterioration of the image abnormality detecting function is notified, and a message for prompting cleaning of a reading sensor of the image reader 41 may be displayed. Alternatively, a cleaning device such as a brush and a suction device may be installed in the apparatus, and automatically clean the reading sensor of the image reader 41 by the cleaning device.

As described above, according to the sixth embodiment, if the change amount of the detection level with respect to the number of image formations of the job is larger than the predetermined value, the deterioration of the abnormality detector 40 is notified, and therefore when the detection level is rapidly changed before and after the job, the abnormality of the apparatus can be warned.

The change amount of the detection level may be obtained at an initial stage and at an latter stage of the job in Step S132, in place of the change amounts of the detection levels before start and after end of the job.

The change amounts of the detection levels before start and after end of the job are stored in the deterioration monitoring process of the image abnormality detecting function. However, the information stored per job may not be the change amount itself of the detection level, as long as the job information stored per job is information from which the change amounts of the detection levels at start time and at end time of the job can be calculated.

The description in each of the aforementioned embodiments is an example of the image forming apparatus according to the present invention, and the present invention is not limited to this. The detailed configuration and the detailed operation of each of the parts composing the apparatus are appropriately changeable without departing from the spirit of the present invention.

For example, the respective processes in the aforementioned embodiments may be combined.

The hardware processor 11 may cause the image forming unit 30 to form a test image in a trimming region of a sheet on which an image related to a job is formed with restriction of a range of a predetermined abnormality level. More specifically, only an image which simulates an image abnormality of an abnormality level equivalent to a user setting value may be formed, and whether this image can be detected as the image abnormality may be checked. An image which simulates an image abnormality of an abnormality level in a range of the user setting value and several stages before and after the user setting value may be formed. The test image is restricted to an image necessary for check around the user setting value, so that a space which forms the test image can be minimized

The hardware processor 11 may cause the image forming unit 30 to form a test image on a front surface and a back surface of a sheet. Surface natures and textures of a front surface and a back surface of a sheet are different depending on the sheet type, and therefore frequencies or degrees of generation of an image abnormality on the front surface and the back surface are sometimes different. As illustrated in FIG. 1, in a case in which the image readers 41A, 41B which read a front surface and a back surface of a sheet are different, performance and a state of the image reader 41A and performance and a state of the image reader 41B are sometimes different. Therefore, an operation confirmation process is performed for a front surface and a back surface of a sheet, so that it is possible to obtain the operation confirmation information of each of the front surface and the back surface.

The hardware processor 11 may perform an operation confirmation process (formation of a test image, detection of an image abnormality, generation of operation confirmation information) for each of regions obtained by dividing a sheet into a plurality of regions. For example, qualities requested by a region including many characters and a region including many images are sometimes different, and therefore the detection level of the abnormality detector 40 is checked for each region.

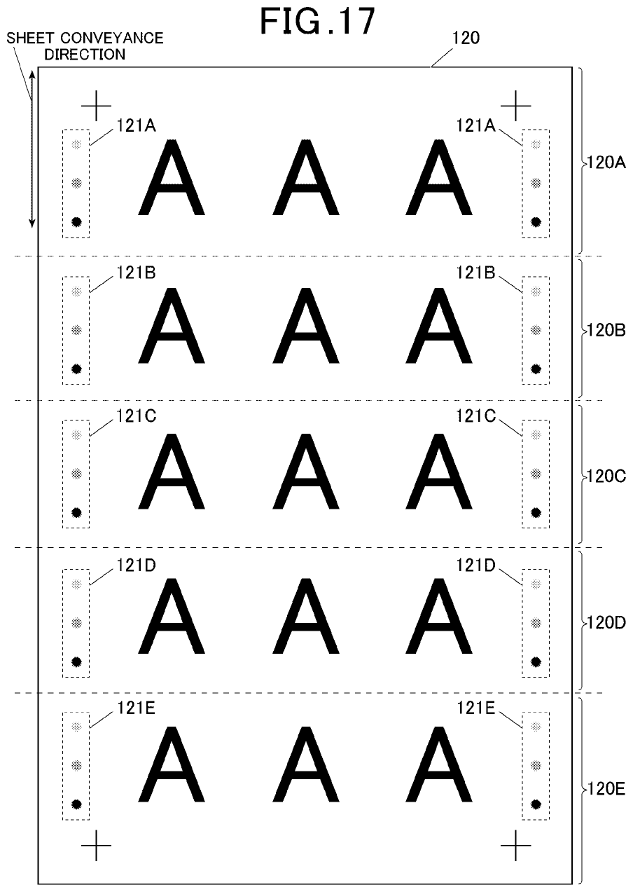

FIG. 17 is an example of a sheet 120 on which the test image is formed to be used to check the detection level of the abnormality detector 40 for each of a plurality of regions. The sheet 120 is divided into a plurality of regions 120A to 120E in the sheet conveyance direction, and images 121A to 121E which simulate spots are formed on the each of the regions 120A to 120E at a plurality of gradations of density. It is checked per region which density of the spot can be detected, so that even in a case in which the respective detection levels per regions are different, it is possible to accurately check the detection levels. Furthermore, the user setting value (OK/NG boundary value) may be able to be set per region.

FIG. 17 is an example of a case in which a sheet is divided into a plurality of regions in the sheet conveyance direction. However, a sheet may be divided into a plurality of regions in the sheet width direction, and the operation confirmation process may be performed per divided region.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image forming unit which forms an image on a sheet;
an abnormality detector which detects an image abnormality from the sheet on which the image is formed; and
a hardware processor which, at the time of execution of a job, causes the image forming unit to form a test image for checking a detection level of the image abnormality by the abnormality detector, causes the abnormality detector to detect the image abnormality from the sheet on which the test image is formed, and performs an operation confirmation process of generating operation confirmation information of the abnormality detector on the basis of a detection result by the abnormality detector.

2. The image forming apparatus according to claim 1, wherein
the detection level is indicated by at least one of a size and a density of the image abnormality.

3. The image forming apparatus according to claim 1, wherein
the operation confirmation information includes information which indicates that the abnormality detector is operating normally, or the detection level at a time when the abnormality detector detects the image abnormality from the test image.

4. The image forming apparatus according to claim 1, wherein
the hardware processor generates text data as the operation confirmation information, in which the text data includes information which indicates that the abnormality detector is operating normally, or the detection level at a time when the abnormality detector detects the image abnormality from the test image.

5. The image forming apparatus according to claim 1, wherein
the hardware processor generates image data as the operation confirmation information, in which the image data is generated by adding a mark indicating a detection portion of an image abnormality to image data obtained by reading the sheet on which the test image is formed.

6. The image forming apparatus according to claim 1, wherein
the hardware processor associates the operation confirmation information with information identifying the job, and stores the associated operation confirmation information in a storage.

7. The image forming apparatus according to claim 1, wherein
the hardware processor associates the operation confirmation information with a detection result of the image abnormality with respect to the job, and stores the associated operation confirmation information in a storage.

8. The image forming apparatus according to claim 1, wherein
the hardware processor notifies a user of the operation confirmation information, and in response to a user input of approval of the operation confirmation information, causes the image forming unit to continue execution of the job.

9. The image forming apparatus according to claim 1, wherein
the hardware processor performs the operation confirmation process at least at start of the job and at end of the job.

10. The image forming apparatus according to claim 1, wherein
in response to the abnormality detector detecting the image abnormality from a portion other than the test image of the sheet on which the test image is formed, the hardware processor notifies a user to prompt the user to select whether or not to continue execution of the job.

11. The image forming apparatus according to claim 1, wherein
the hardware processor causes the image forming unit to form the test image and an image related to the job on different sheets.

12. The image forming apparatus according to claim 11, wherein
the hardware processor performs the operation confirmation process with respect to each sheet type to be used in the job.

13. The image forming apparatus according to claim 1, wherein
the hardware processor causes the image forming unit to form the test image in a trimming region of a sheet on which an image related to the job is formed, and generates the operation confirmation information with respect to each page.

14. The image forming apparatus according to claim 13, wherein
the hardware processor causes the abnormality detector to eject a sheet on which the image abnormality is detected, to a sheet ejection tray different from a normal sheet ejection tray, and causes the image forming unit to form again an image corresponding to the sheet on which the image abnormality is detected, on another sheet, and
in response to the abnormality detector detecting an image abnormality from the sheet on which the test image is formed but in a portion of the trimming region other than the test image, the hardware processor causes, as an exception, the image forming unit to continue execution of the job with neither ejecting the sheet on which the test image is formed to the different sheet ejection tray nor forming again the image corresponding to the sheet on which the image abnormality is detected, on the other sheet.

15. The image forming apparatus according to claim 13, wherein
the hardware processor causes the image forming unit to form the test image in the trimming region of the sheet on which the image related to the job is formed, in which an abnormality level of the test image is limited to a predetermined range.

16. The image forming apparatus according to claim 1, wherein
in response to the detection level of the abnormality detector becoming worse than a threshold for quality determination of an image abnormality preset by a user during the job, the hardware processor temporarily stops the job, causes the image forming unit to form a second test image for checking the detection level of the image abnormality by the abnormality detector more specifically than the test image, causes the abnormality detector to detect an image abnormality from the sheet on which the second test image is formed, and gives a notification of a current detection level obtained from the second test image.

17. The image forming apparatus according to claim 1, wherein
in response to the number of image abnormalities detected exceeding a predetermined number during the job, the hardware processor temporarily stops the job, causes the image forming unit to form a third test image for checking the detection level of the image abnormality by the abnormality detector more specifically than the test image, causes the abnormality detector to detect an image abnormality from the sheet on which the third test image is formed, and give a notification of a current detection level obtained from the third test image.

18. The image forming apparatus according to claim 1, wherein
the hardware processor stores a change amount of a detection level of the abnormality detector at each of start and end of the job with respect to each job in a storage along with the number of image formations, and in response to the change amount of the detection level with respect to the number of image formations being greater than a predetermined value, the hardware processor gives a notification that the abnormality detector is deteriorated.

19. The image forming apparatus according to claim 1, wherein
the hardware processor causes the image forming unit to form the test image on each of a front surface and a back surface of a sheet.

20. The image forming apparatus according to claim 1, wherein
the hardware processor performs the operation confirmation process per region obtained by dividing a sheet into a plurality of regions.
